(19) United States
(12) Patent Application Publication
(10) Pub. No.: US 2007/0100856 A1
(43) Pub. Date: May 3, 2007

(54) Account consolidation

(75) Inventor: Bjorn Ebbesen, Hamburg (DE)

Correspondence Address: MORRISON & FOERSTER LLP, 425 MARKET STREET, SAN FRANCISCO, CA, 94105-2482, US

(73) Assignee: Yahoo! Inc., Sunnyvale, CA (US)

(21) Appl. No.: 11/256,296

(22) Filed: Oct. 21, 2005

(51) Int. Cl. G06F 7/00

(52) U.S. Cl. 707/101

(57) ABSTRACT

In one aspect a system and method for aggregating data from multiple content nodes are provided. In one example, a system for aggregating content nodes on a single content node backend includes logic operable to associate a first content node with a second content node on a first backend, wherein the first content node is hosted by the first backend, the second content node is mirrored from a remote location, and the second content node is hosted by the remote location. The data of the first and second content nodes may be grouped as a single dataset (e.g., a connected dataset) hosted by the first backend, and the data of the first and second content nodes may be organized as separate folders of the connected dataset.

### RELATED APPLICATION

This application is related to the following U.S. patent application: Ser. No. 11/182,287 (attorney docket no. 324212000900), filed Jul. 14, 2005, entitled CONTENT ROUTER, to Torsten SCHULZ et al., which is hereby incorporated by reference in its entirety as if fully set forth herein.

### BACKGROUND

1. Field

This relates generally to the sharing and organization of data across various content nodes, e.g., accounts, devices, exchanges, etc., and in one aspect, to associating or aggregating data of related content nodes across various backends (including, e.g., one or more servers), which may improve user experience and device performance.

2. Description of Related Art

The use of electronic messaging (email) and related account services has become considerably more common in recent years. The increasing ease and convenience of sending email messages have for their part also increased the use of email in communication.

The concept of an account including a remote mailbox refers generally to a property, such as a memory provided with one or more server computers (sometimes referred to herein as a “backend”) such as an email server, by means of which the owner of the remote mailbox can receive email messages. For such a remote mailbox a unique address is determined, which is typically of the format name@domain.com, wherein emails can be directed from the receiving email server to the correct remote mailbox by means of this address. The email server generally includes a computer (server), which communicates with the data transmission network. The email server can, for example, be a server connected to the local area network of a company, or a server of an operator providing for email services such as Yahoo!® mail, which is well known in the art.

Additionally, user accounts often have various information management services or applications, such as Personal Information Management (PIM) applications with related databases associated therewith, where the related databases are supported or hosted on the account backend. For instance, applications such as contacts, calendar, tasks, notes, and the like have associated databases including content associated with the application programs, e.g., contact information (including, e.g., addresses, phone numbers, email addresses, etc.), calendars (including, e.g., meetings, birthdays, holidays, etc.), and the like. The databases are generally stored with one or more servers of the account backend, and accessible through the account.

Users often have various email addresses and remote accounts including mailboxes (electronic mailbox, email box) and associated applications related thereto. For example, a user typically has at least one account and email address provided by an employer, which account is primarily used for communication and matters related to work. Further, for personal purposes, a user typically has at least one account and email address provided by a service provider, e.g., by an Internet operator. Additionally, accounts and email addresses may be provided by government agencies, education systems, and the like.

Users typically have multiple accounts and it has becoming increasingly difficult for users to manage the accounts and related information stored with each of the accounts. For example, a work account including, e.g., email, calendar, and contact applications, may have a first set of contacts and related information associated therewith and a personal email account including, e.g., email and contact applications, may include a second set of contacts and related information associated therewith. The first and second set of contacts may include some overlap of information (whether similar or identical data). Further, as a user adds or changes information to one account, e.g., adds or changes a phone number for a contact, where the particular contact is included in two different accounts, the information is generally not synchronized or otherwise propagated to the other user account without the user manually making such a chance in each account.

Accordingly, it is desired to have an account which allows a user to access and/or modify information from at least a second account, e.g., that is hosted by a separate backend. Further, systems and methods that allow access to data associated with multiple content sources or accounts are desired.

### SUMMARY

According to one aspect provided here, systems and methods for aggregating data are provided. In one example, a system for aggregating data of remote content nodes with a single content node backend includes logic operable to associate data from a first content node with data from a second content node on a first backend, wherein the first content node is hosted by the first backend, the data from the second content node is mirrored from a remote location, and the second content node is hosted by the remote location. The data of the first and second content nodes may be grouped as a single dataset (e.g., a connected dataset) hosted by the first backend, and the data of the first and second content nodes may be organized as separate folders of the connected dataset.

According to another aspect, a device is provided. In one example, the device includes logic operable to access a connected dataset including data from two or more content nodes associated with two or more backends, the connected dataset located with a backend of one of the content nodes and accessible by the device.

According to another aspect, a method for aggregating data associated with different content nodes on one content node backend is provided. In one example, the method includes associating data of a first content node with data of a second content node on a first backend, wherein the first content node is hosted by the first backend, the data of the second content node is mirrored from a remote location, and the second content node is hosted by the remote location.

According to another aspect, a computer program product comprising program code associated with aggregating multiple content nodes with one content node backed provided. In one example, the computer program product includes program code operable to associate data of a first content node with data of a second content node on a first backend, wherein the first content node is hosted by the first backend, the data of the second content node is mirrored from a remote location, and the second content node is hosted by the remote location.

The present invention and its various aspects are better understood upon consideration of the detailed description below in conjunction with the accompanying drawings and claims.

### BRIEF DESCRIPTION OF THE DRAWINGS

FIG. 1 schematically illustrates an exemplary environment in which certain aspects described herein may be used;

FIG. 2 schematically illustrates various content nodes associated with a connected dataset based on application type;

FIGS. 3A-3C schematically illustrate various aspects of a connected dataset system having multiple content nodes;

FIG. 4 schematically illustrates the handling of similar or identical data entries for a connected dataset;

FIGS. 5A and 5B schematically illustrate a connected dataset system with the removal and addition of a content node and associated data; and

FIG. 6 illustrates an exemplary user interface accessing a connected dataset in one example.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

Some examples described herein provide systems and methods for providing an aggregated backend (e.g., comprising one or more server computers) that supports a user account (e.g., such as a Yahoo! email account or the like), where the aggregated backend includes data available on other backends of associated content nodes (e.g., other users accounts, exchanges, devices, etc.). For example, a user may have two or more email accounts, including various applications, such as email, contacts, calendar, and the like associated with each account. A first user account backend may mirror data of a second user account, such that data of the second account is accessible through the first user backend. The aggregated data is principally organized as a connected dataset having separate substructures, e.g., folder or other data file grouping system, provided by different content nodes. In one example, a connected dataset is established with an aggregated backend for each application type, whereby aggregation of two or more substructures, e.g., folder or other data file grouping system, provided by other content nodes also associated with or linked to the connected dataset, is done. In this manner a user may access data stored by two or more backends through one content node—the aggregated backend.

In some examples, a connected dataset is provided to or accessible by other content nodes, e.g., other accounts, exchanges, devices. Various filters may be used to access portions of the connected dataset not hosted by the local backend of the content node accessing the connected dataset. In one particular example, the content node includes a mobile device such as a smart phone or the like, which by accessing the connected dataset may access other content nodes linked to the connected dataset.

In another aspect described herein, a database identifies and allocates an item identification (ID) to each data entry and also folder identification to folders structuring the data entries of the associated content nodes, e.g., a folder of contacts, a contact entry, a calendar entry, and the like. As data from different content nodes are associated or linked together and added to a connected dataset, the item IDs of different entries are matched-up for duplicates in different folders such that modifications, deletions, or additions of similar or identical information are treated appropriately. For example, if a user desires to delete a contact from all associated content nodes, the item ID from the originating content node assists in identifying identical contacts in other content nodes and deleting them. For example, if a user desires to delete a contact from a folder (but still resides in other folders) an update is sent using its item ID from the originating content node which assists in identifying identical contacts in other content nodes and updating them. Further, on the importation of data organized in folders, the folder ID assists in reducing the occurrence of duplicate folders added to the connected dataset. Such item and folder IDs may facilitate various schemes and treatment of data upon importation, deletion, modification, and the like, as are well known in the art.

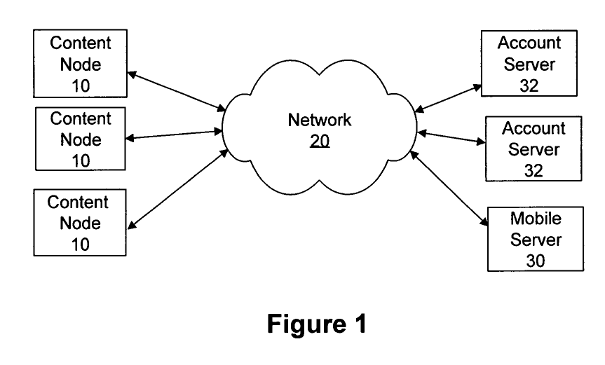

FIG. 1 illustrates an overview of an exemplary environment in which some aspects described here may be used. Not all the components may be required, and variations in the arrangement and type of the components may be made without departing from the spirit and scope of the inventions. Broadly speaking, one or more content nodes 10 (including, for example, content sources such as user accounts, exchanges, etc, as well as content sinks such as mobile devices, etc.) are connected through a network 20 to one or more servers, including, account servers 32 (e.g., email servers), mobile servers 30, and the like.

Additionally, a content node 10 may include computer device, such as a personal computer or a mobile device. Content node 10 may communicate with network 20 and one or more servers, e.g., a mobile server 30 and one or more email servers 32. A mobile computer device may communicate via a wireless network, such as a wireless gateway, e.g., a cellular, satellite, or other wireless network. Additionally, the computer device may communicate via a non-wireless network such as a cable or fiber optic network, or a combination of wireless and non-wireless systems. The computer device may include suitable hardware and software, such as a processor connected to an input device such as a keyboard, a network interface, a memory, and a display. The memory may include logic or software operable with the device to perform some of the functions described herein. The device may be operable to include a suitable interface for a messaging facility, such as an email inbox, instant messaging (IM), short messaging service (SMS), multimedia messaging service (MMS), and the like. The device may further be operable to display a web browser for accessing the Internet or user accounts, including webmail environments such as a Yahoo!® mail account or Hotmail® account, for example.

Network 20 may be in communication with or include one or more server and database systems in communication with one another and capable of wirelessly communicating with devices of a plurality of users. Exemplary server systems may include a mobile server, email sever, web server, voice messaging server, and the like. Further, network 20 may include a wireless network and one or more local area networks (LANs) and/or wide area networks (WAN), such as the Internet, that enables communication between various users, devices, servers, agents, modules, clients, processors, and the like.

Network 20 includes suitable circuitry for connecting servers 30 and 32 to network 20, and is constructed for use with various communication protocols including, but not limited to, TCP/IP, UDP/IP, SMS, IM, and WAP. Network 20 may include or interface with circuitry and components for communicating information, such as email messages, media objects, graphical displays, advertiser data, and the like, over a wired and/or wireless communications medium. Further, network 20 may include or be associated with an SMS center and/or MMS center for transferring files.

Additionally, in one example, a router is associated with network 20 and/or one or more servers, e.g., server 30 and 32, and operates to process and deliver content between content nodes 10 and servers 30 and 32. For example, the router may filter data and data structure, parse out data segments, import data, add item IDs to data segments, and the like according to examples provided herein. Additionally, the router may store segments not initially sent to content node 10 in a repository (e.g., memory) for later delivery to content node 10 and/or delivery to additional content nodes.

It should be noted that although the exemplary methods and systems described herein describe use of separate servers and databases for performing the various functions, other embodiments could be implemented by storing the software or programming that operates described functions on a single server or any combination of multiple servers as a matter of design choice so long as the functionality described herein is performed. Although not depicted in the figures, the server systems 30 and 32 generally include such art recognized components as are ordinarily found in server systems, including but not limited to processors, RAM, ROM, clocks, hardware drivers, associated storage, and the like.

From a content node 10, a user may access data of an account hosted by a backend (including, for example, one or more server computers). The account may include one or more applications, whereby a user may use commands to enter, store, access, update, modify, and/or delete content or metadata (i.e., information about content). Content may have one of various content types, such as contacts, calendar events, tasks, emails and/or library items. Furthermore, content may include a personal information management (PIM) content type, which may include a contact, calendar event, or task.

A user account may include, e.g., one or more of a personal email account on an email server (e.g., Yahoo!® Mail), a family photo album account on a photo server (e.g., Yahoo!® Photos), a PIM account on a PIM server (e.g., Yahoo!® Address book or Yahoo!® Notepad), a music library account on a multimedia library server (e.g., Yahoo!® Music), and the like. Furthermore, a user account typically includes two or more content types and applications. For example, a user account may have access to email, PIM information, calendar information, and a notepad, such as with a Yahoo!® user account.

An account may also be associated with or at least accessible by a computer device. Such a user device may be a wired device, such as a home personal computer, an office PC, a digital camera or a set-top box, or may be a wireless device, such as a mobile phone, a laptop, handheld PC, or a digital camera with wireless capabilities. Some devices may have both wired and wireless capabilities, while other devices may have either wired or wireless capabilities. Some user devices may have access to a single content type. Other user devices have access to two or more content types. The device may include PIM devices such as a Blackberry® or a Treo®, or more dedicated mobile phones that provide more limited information management services. Information management services may include, for example, PIM services such as calendar, address book, tasks, and notes. A calendar typically maintains time-related organizational attributes such as events (e.g., meetings, birthdays, holidays) related to corresponding date and time ranges. An address book typically maintains organizational attributes related to a person (e.g., a legal “person” such as a human or business entity, or even a pet), a place (e.g., the person's address), or other contact information attributes (e.g., telephone or facsimile numbers, email addresses, etc.).

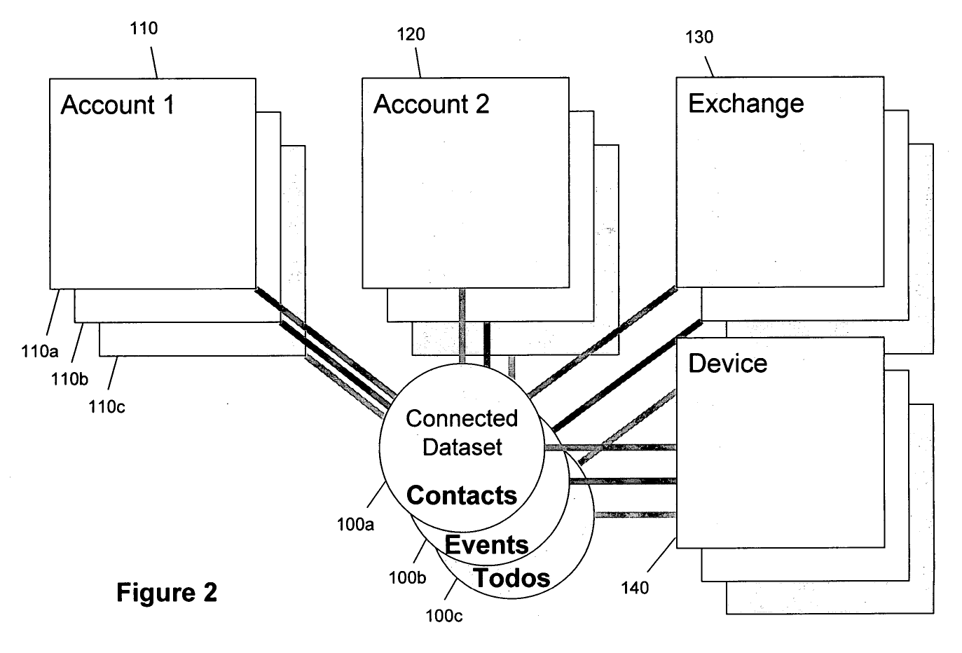

FIG. 2 schematically illustrates various connected datasets 100a-100c and associated content nodes 110, 120, 130, 140 for particular applications (e.g., represented by 110a-110c with content node 110). In this example, content nodes 110, 120, 130, 140 include user accounts, Account 1 and Account 2, Exchanges A and B, and a Device respectively. The connected datasets 100a-100c are associated with content nodes 110, 120, 130, 140 based on application type as shown. Additionally, the data of the connected datasets 100a-100c are hosted at the backend (e.g., one or more servers) for one of the content nodes 110, 120, 130, 140. In this example, connected datasets 100a-100c are hosted with the backend of content node 110 and Account 1 (i.e., with one or more server computers associated with content node 110 and Account 1). The number and types of content nodes are illustrative only, and as will be described in detail herein, various content nodes, including content sources, content sinks, accounts, exchanges, devices, etc., and the number of content nodes may be associated or connected together as described.

Account 1 and Account 2 may include an email account such as a Yahoo!® mail, MSN® mail, or similar internet provided accounts. Typically, such accounts include, in addition to standard, well known email functions, one or more applications such as contacts, calendars, events, to do lists (“ToDos”), and the like. An Exchange, e.g., associated with a work or business account may include similar applications and be connected or associated with the connected datasets 100a-100c as illustrated. Additionally, a Device included and associated with the connected datasets 100a-100c, may be associated with the connected datasets 100a-100c for (at least) accessing the connected datasets, but not necessarily to provide data to the connected datasets 100a-100c. The Device may include a Symbain phone or other mobile devices such as a PDA, mobile telephone, smart phone, pager, walkie talkie, radio frequency (RF) device, infrared (IR) device, Wi-Fi device, pocket personal computer, tablet personal computer, laptop/desktop computer, or other integrated devices combining one or more of the preceding devices.

As shown, connected datasets 100a-100c are associated with content nodes 110, 120, 130, 140 based on application type; in this example shown as Contacts 100a, Events 100b, and ToDos 100c. For each application type shared by the associated content nodes 110, 120, 130, 140, one connected dataset 100a-100c is hosted on a single backend (e.g., one or more servers) associated with one of the content nodes, for example, Account 1. A user may therefore access data from one or more of the connected datasets 100a-100c through Account 1 and access both data associated with Account 1 and data associated with other “connected” content nodes.

Additionally, in one example, a device connected to connected datasets comprises a database for each application type comprising data that is structured into subsets of data associated with various content nodes providing folders to the connected datasets. For example, a single contact folder in one account, e.g., an Outlook program, is maintained as a single data subset of the entire Contact connected dataset 100a. The content node may thereby provide data in subsets identified as individual folders or the like within the connected dataset, e.g., a contact folder associated with an Outlook program of one of the content nodes is represented by a single folder with the connected datasets 100a-100c.

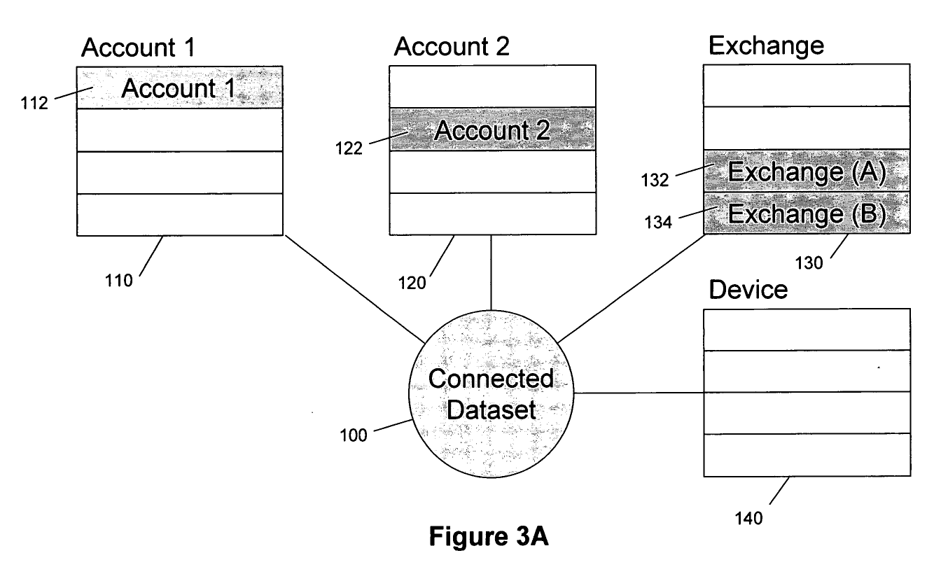

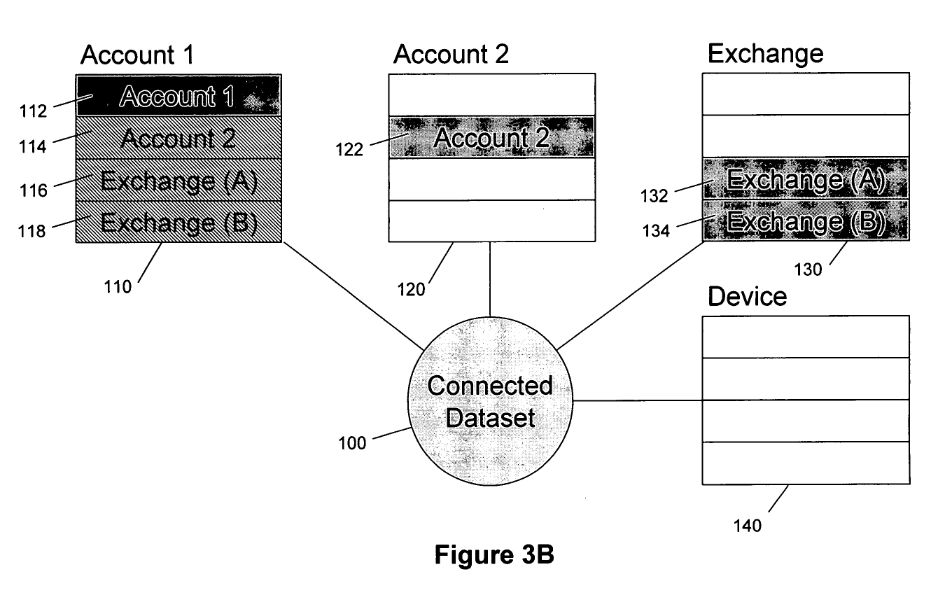

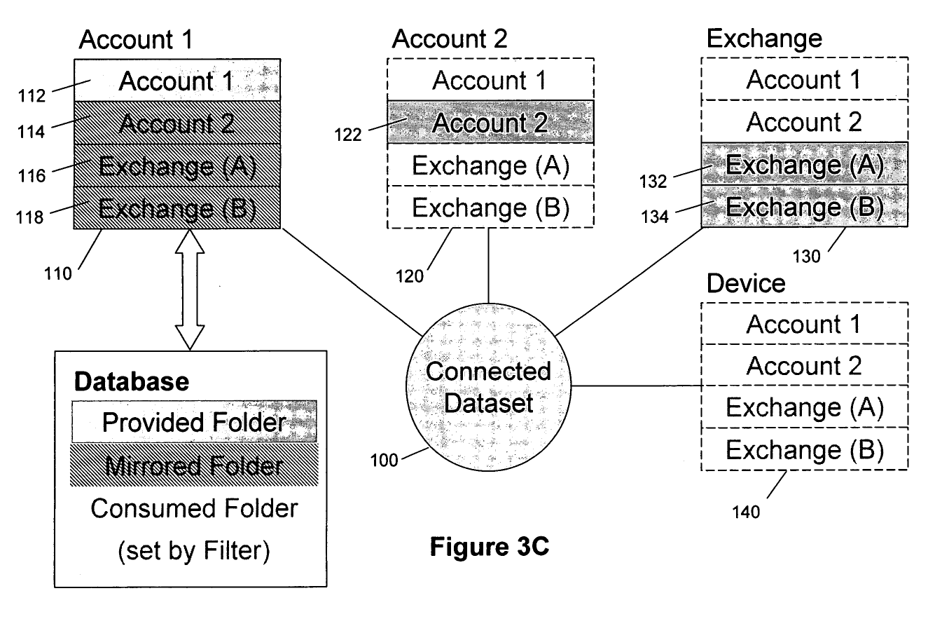

FIGS. 3A-3C illustrate various aspects of respective folders for different content nodes in one example for a connected dataset for a particular application, e.g., for a “Contacts” application. As shown, Account 1 includes a folder 112, which is a substructure or subset of connected dataset 100, corresponding to the contacts initially stored with Account 1. Folder 112, as it is seen from Account 1, is referred to herein as a provided folder because it is original to the backend of Account 1. Similarly, Account 2 includes a provided folder 122 of contacts stored with Account 2, and Exchanges A and B include provided folders 132 and 134 of contacts stored therewith.

With reference to FIG. 3B, the Account 1 backend includes the connected datasets 100, accessible through Account 1 as folder representatives 114, 116, and 118, which are mirrored from related (but remote) content nodes providing folders “Account 2”, and “Exchange A” and “Exchange B” (i.e., folders 122, 132, and 134). Folder representatives 114, 116, and 118 of folders 122, 132, and 134 are referred to herein as mirrored, because they are mirrored from content nodes 120 and 130, but are not provided on the same backend/server system as content node 110 and folder 112). In this manner, Account 1 may include multiple folders, which corresponds to the folders 122, 132, and 134 for each associated account, exchange, etc. via connected dataset 100, and a user accessing Account 1 accesses data available on all connected folders 122, 132, and 134.

The content nodes 110, 120, 130, 140 may be associated together and synchronized by various known router and synchronization systems and methods. Additionally, exemplary methods and systems are described in U.S. patent application Ser. No. 11/182,287. For example, a data item with a change may generate a command including changed content or metadata indicating a change to the content, which may be communicated to the other content nodes via a delivery to those content nodes. The router may include logic or the like for examining the contents of the command and selecting possible content nodes for changes.

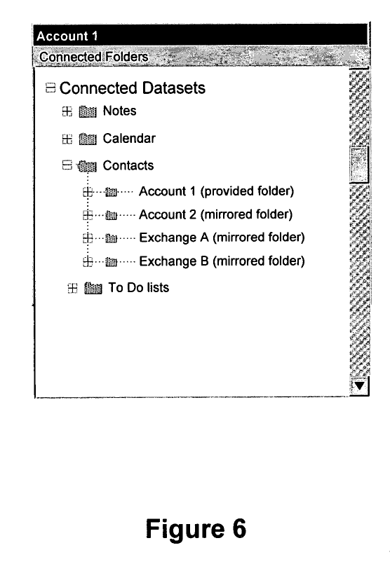

In one example, the datasets from the other content nodes are separated into individual folders, for which all are being mirrored. In one example, the folders are displayed as conventional folders similar to an Outlook program folder tree or the like (see e.g., FIG. 6, which illustrates a screenshot of an exemplary folder tree structure; of course, various other arrangements of the connected dataset and substructures are possible. For example, a window may include folder icons absent a tree structure associated with each connected dataset or the like). The separate folders and ability to access all connected datasets allows a user to manage additional content sources from a single account. For example, a user accessing the application program associated with connected dataset 100 (e.g., Contacts) through Account 1 (e.g., a Yahoo!® mail account) may access not only the folder 112 associated with Account 1, but may also access the folders 114, 116, and 118, which mirror folders 122, 132, and 134 associated with Account 2 (e.g., an MSN® mail account), and Exchanges A and B (e.g., work or business accounts) respectively.

FIG. 3C illustrates content nodes other than content node 110 and Account 1 as data consumers, e.g., accessing folders not provided by them through connected dataset 100. Thus, all content nodes associated with the connected dataset 100 may sign-up for accessing one or more folders available in connected dataset 100, i.e., folders that are not provided by the content node itself. Additional filter settings may be used to define subsets on the selected folder from connected dataset 100 (thereby not duplicating a provided folder). For example, Account 2 may subscribe to receive a folder not provided by the Account 2 backend itself, such as folder 112 of Account 1 and so on. Thus, a user with access to Account 2 may also view all of the connected dataset 100.

Additionally, in one example, the Device (content node 140) has access to the related folders 112, 122, 132, and 134 from Account 1, Account 2, and Exchanges A and B. In one example, the Device is associated with the connected dataset 100 associated with all content nodes. In another example, the Device may access two or more content nodes to obtain some or all of the connected dataset 100. It should be recognized, that some devices (and more generally, some content nodes) may not be capable of configuring to access folders provided by other content nodes. Accordingly, in some instances, a folder may be completely or partially unseen to other content nodes associated with the connected dataset 100. For example, the Device and/or content node hosting the connected dataset 100 may include a filter to only retrieve appropriate folders or data within folder suitable for the device. In particular, certain content may be filtered out based on the capabilities of the Device.

Additionally, as described herein, additions, deletions, and modifications to the data may be propagated through to the other content nodes and/or backgrounds by any suitable means. For example, a user may move or copy an item from one folder to another. A contact entry or the like may be moved from folder 112 to folder 114. Thereafter, Account 1 will move the contact entry from folder 112 and add the contact entry to folder representative 114 via the connected dataset 100 (where folder representative 114 corresponds to the provided folder 122 of Account 2). Folder 122 of Account 2 may subsequently synchronize with folder representative 114 and connected dataset 100 from the backend of Account 1. The synchronization may include one or more suitable systems/methods for synchronizing two or more content nodes.

In another example, a data entry included with folder 112 of Account 1 may be identified as identical with a data entry included with folder 222 of Account 2. Some components like the content node Account 1 backend or “data consolidation” in a content router may identify the two identical data entries and propagate modifications (due to merge result) with summed up folder IDs through connected dataset 100. This function may take a variety of forms including known routing and/or synchronization methods to propagate the modification or deletion of data and content to the other content nodes. Exemplary content router systems and methods are disclosed in U.S. patent application Ser. No. 11/182,287, which is hereby incorporated by reference in its entirety as if fully set forth herein. Such a content router is operable, for example, to allocate an item identification (“ID”) to each content type of a user's connected content nodes. The item IDs allocated to the various entries may then be used (where applicable) to propagate a change or deletion to one entry to other entries associated with other folder and content nodes.

In one example, each item is allocated a global unique item ID within that connected dataset, and for each connected content node, the data item has a local ID used by the local content node. The global ID is primarily used by the router to maintain ID mappings and processes mapping when a data entry is entering or leaving the router for a specific content node. The item ID will not change if the item moves from one folder to another or if the item occurs in more than one folder. The item ID is independent from the folder ID. Folders are only used to structure the data—similar to applying categories to items.

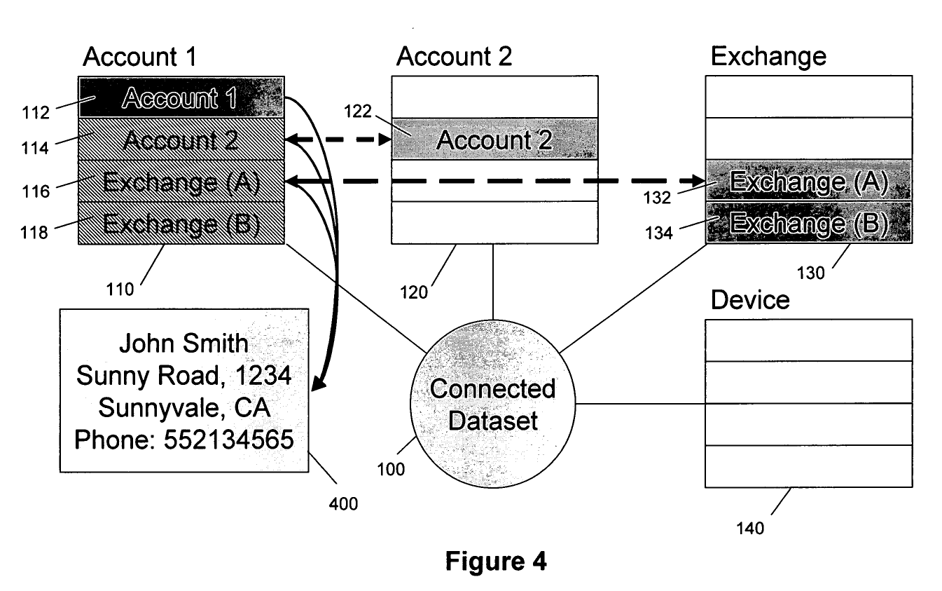

FIG. 4 illustrates an instance where a similar or identical item is included with several folders of the connected dataset 100. For example, the connected dataset 100 includes a similar or identical item in two or more folders such that a user accessing connected dataset 100 through Account 1 may have a similar or identical entry 400 stored in more than one folder. Illustrated in this instance, the identical contact entry for “John Smith” is located in folder 112, 114, and 116. The backend of Account 1 identifies and allocates each entry of the connected dataset 100 with the same item ID (as described previously) such that multiple entries in the database may be associated together in an efficient manner.

The identification and recognition of the similarity of an entry in multiple folders of connected dataset 100 allows a user the option to modify or delete a content item such as entry 400 in one folder and effect a modification or deletion to similar content items in other folders. In other examples, the user may select to modify or cancel an entry only within one folder, without effecting similar or identical entries in related folders. For example, a user may desire to delete or edit a personal contact entry listed folder “Exchange A” (e.g., a work account), without deleting or editing the entry as it is stored and viewed in folder “Account 1” (e.g., a personal account). In one example, when a user modifies or cancels a content item, the user may be prompted as to whether the modification or cancellation is desired to extend to other content items deemed identical by the system or to create a copy as a new entry. Additionally, the system may more readily identify a duplicate entry being added within a single folder to reduce the occurrence of multiple identical entries within an individual folder.

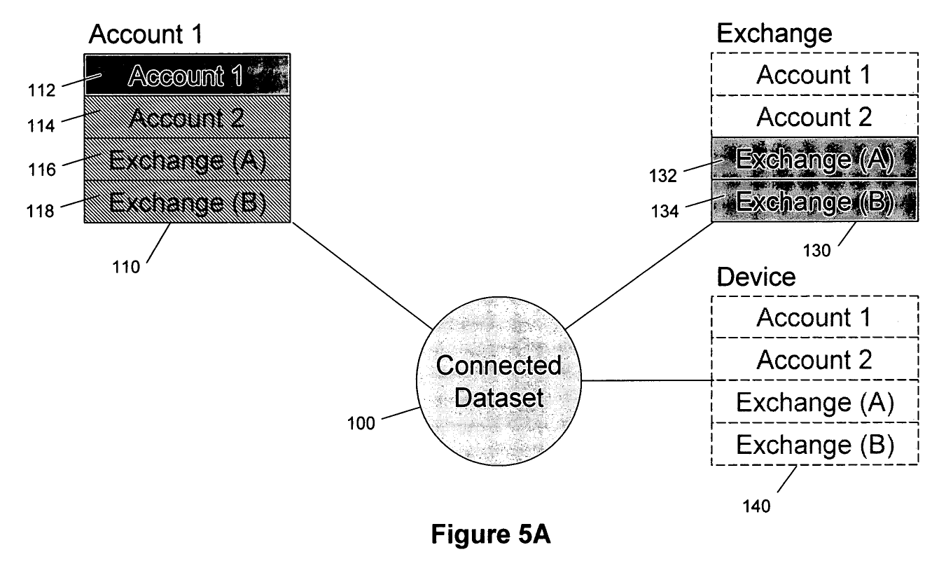

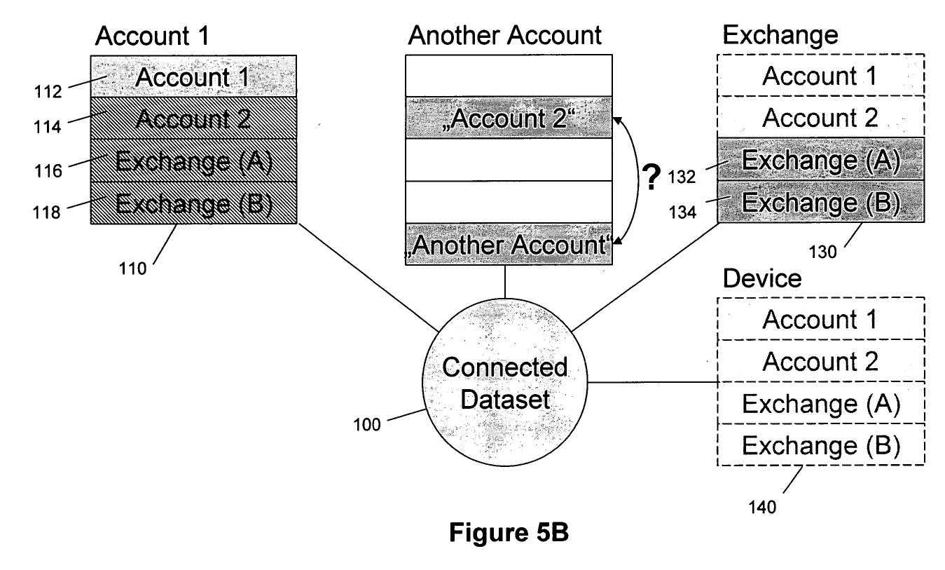

FIGS. 5A and 5B illustrate another aspect of the connected datasets provided herein. In this example, the connected dataset system is similar to that of FIG. 3C, however, the Account 2 folder provided to the connected dataset 100 have been removed (or are otherwise no longer in contact with the connected dataset 100), but not its folder “Account 2”. For example, Account 2 may be closed by the user, the server of Account 2 may be down or disabled for a period of time, or otherwise unavailable to backend of Account 1 and the content node supporting connected dataset 100. As seen, folder representative 114, previously mirrored from folder 122 of Account 2 (as of the last update or information obtained from Account 2) remains not only hosted but provided by Account 1 and still available to be consumed by connected nodes of the system. In this instance, folder 114 is considered “provided” by Account 1 because it is no longer associated with an originating content node. Because the connected dataset 100 is fully hosted at Account 1, Exchanges A and B, and the Device may continue to consume folder 114 via connected dataset 100 without any interruption.

FIG. 5B illustrates the addition of an account to the connected dataset system, which may or may not be a previously removed account, such as folder 122 of Account 2 shown in FIG. 5A. Thus, the system desirably avoids adding a duplicate folder if the new folder ID is already known because the old folder ID is still available at the Account 1 backend as a provided folder and each account creates global unique folder IDs. If the new folder is detected as known folder, the “ownership” of the folder is removed from Account 1 backend and assigned to the new (old) account. The new (old) account now provides folder 122 which has a mirror folder representative 114 on Account 1 backend.

The data of the new (old) account will be imported as belonging to the new (old) folder ID followed by identifying and unifying identical items by dedicated components (as described previously) such that duplicates will we avoided in case of an addition of a former connected account.

It is noted that if the same folder is added again as that which was removed, the other content nodes, e.g., the other accounts, Exchanges, and Device, are not affected, i.e., access by the content nodes to the folder items from the removed folder remained unchanged. If the account is the same but includes some changes, the changes will be detected by a component (Account 1 or data consolidation) and connected dataset 100 will be updated accordingly. Additionally, the device (e.g., a mobile phone or the like) can be disconnected/reconnected without changing the connected dataset 100. In one example, if the Device imports data, but it is not a folder provider, the data is “unfoldered”, and it is stored in folder 112 of Account 1 by default (if not matching identical item from any other folder was found). In other examples, other default schemes are possible.

In one example, if a new folder is added (i.e., the folder is not a folder already known in the connected dataset 100), the data is imported with that folder ID into the connected dataset. The folder (and all its data) are mirrored at (aggregating) Account 1 backend. Additionally, all data is processed to identify identical entries.

FIG. 6 illustrates an exemplary user interface (which is located on a connected device) for accessing data of a connected dataset system in one example. As illustrated, various applications may be included where one or more of the applications include a connected dataset as described herein. In this example, a connected dataset associated with a contacts application is expanded to show various folders associated with linked or connected datasets stored with other backends. Various other organizations and/or presentations of the connected datasets and associated content nodes are possible.

Although the present invention has been described in connection with various examples and aspects, it is not intended to be limited to the specific form set forth herein. Rather, the scope of the present invention is limited only by the claims. Additionally, although a feature may appear to be described in connection with a particular example or aspect, one skilled in the art would recognize that various features of the described examples and aspects may be combined in accordance with the invention. Moreover, aspects of the invention describe in connection with an example or aspect may stand alone as an invention.

Moreover, particular examples have been discussed and how these examples are thought to address certain disadvantages in related art. This discussion is not meant, however, to restrict the various examples to methods and/or systems that actually address or solve the disadvantages.

What is claimed is:

1. A system for aggregating data of remote content nodes, the system comprising logic operable to:
associate, on a first backend, first data of a first content node with second data of a second content node, wherein:
the first content node is hosted by the first backend,
the second data is mirrored from a remote location, and
the second content node is hosted by the remote location.

2. The system of claim 1, wherein the first data and second data are grouped as a single dataset on the first backend.

3. The system of claim 1, wherein the first data and second data are organized into respective folders of a connected dataset on the first backend.

4. The system of claim 1, wherein the first and second content nodes comprise user accounts.

5. The system of claim 1, wherein the first content node comprises a user account and the second content node comprises at least one of a user account, an exchange, or a remote device.

6. The system of claim 1, wherein the data of the first and second content nodes are associated together based on an information management service.

7. The system of claim 6, wherein the information management service comprises at least one of a contact, calendar, or task application.

8. The system of claim 1, wherein the data of the first and second content nodes are accessible by a third content node accessing the first backend.

9. The system of claim 8, wherein the third content node comprises a mobile device.

10. The system of claim 1, wherein the second content node is mirrored from a content node hosted by a second backend.

11. The system of claim 1, further comprising logic operable to associate an item identification to data entries of the first content node and to data entries of the second content node, and logic operable to compare the item identifications of data entries to identify identical data entries.

12. A device comprising logic operable to:
access a connected dataset comprising data associated with two or more content nodes, the connected dataset located on a backend of one of the content nodes and accessible by the device.

13. The device of claim 12, wherein the data of the first and second content nodes are grouped as a single dataset with the first backend.

14. The device of claim 12, wherein the data of the first and second content nodes are accessible as separate folders of a connected dataset.

15. The device of claim 12, wherein the data of the first and second content nodes are associated together based on an application program.

16. The device of claim 15, wherein the application program comprises at least one of a contact, calendar, or ToDo application.

17. A method for aggregating data associated with multiple content nodes, the method comprising:
associating, on a first backend, first data of a first content node with second data of a second content node, wherein:
the first content node is hosted by the first backend,
the second data is mirrored from a remote location, and
the second content node is hosted by the remote location.

18. The method of claim 17, wherein the first data and the second data are grouped as a single dataset on the first backend.

19. The method of claim 17, wherein the first data and second data are organized into respective folders of a connected dataset on the first backend.

20. The method of claim 17, wherein the first and second content nodes comprise user accounts.

21. The method of claim 17, wherein the first content node comprises a user account and the second content node comprises at least one of a user account, an Exchange, or a remote device.

22. The method of claim 17, further comprising associating the first and second content nodes together based on an information management service.

23. The method of claim 22, wherein the information management service comprises at least one of a contact, calendar, or task application.

24. The method of claim 17, wherein the data of the first and second content nodes are accessible as separate folders of a connected dataset.

25. The method of claim 17, wherein the data of the first and second content nodes are accessible by a third content node accessing the first backend.

26. The method of claim 25, wherein the third content node comprises a mobile device.

27. The method of claim 17, wherein the second content node is mirrored from a content node hosted by a second backend.

28. The method of claim 17, further comprising associating an item identification to data entries of the first content node and to data entries of the second content node, and comparing the item identifications of data entries to identify at least similar data entries.

29. A computer program product comprising program code associated with aggregating data of multiple content nodes, the computer program product comprising:
program code operable to associate, on a first backend, first data of a first content node with second data of a second content node, wherein:
the first content node is hosted by the first backend,
the second data is mirrored from a remote location, and
the second content node is hosted by the remote location.

30. The computer program product code of claim 29, wherein the first data and the second data are grouped as a single dataset on the first backend.

31. The computer program product code of claim 29, wherein the first data and second data are organized into respective folders of a connected dataset on the first backend.

32. The computer program product code of claim 29, wherein the first and second content nodes comprise user accounts.

33. The computer program product code of claim 29, wherein the first content node comprises a user account and the second content node comprises at least one of a user account, an exchange, or a remote device.

34. The computer program product code of claim 29, further comprising program code operable to associate the data of the first and second content nodes together based on an information management service.

35. The computer program product code of claim 34, wherein the information management service comprises at least one of a contact, calendar, task application.

36. The computer program product code of claim 29, wherein the data of the first content node and the data of the second content node are accessible as separate folders of a connected dataset.

37. The computer program product code of claim 29, wherein the data of the first and second content nodes are accessible by a third content node accessing the first backend.

38. The computer program product code of claim 37, wherein the third content node comprises a remote device.

39. The computer program product code of claim 29, wherein the data of the second content node is mirrored a second backend.

40. The computer program product code of claim 29, further comprising program code operable to associate an item identification to each data entry of the first content node and to each data entry of the second content node, and to compare the item identifications of data entries to identify at least similar data entries.
